(19) United States
(12) Patent Application Publication
(10) Pub. No.: US 2025/0341070 A1
(43) Pub. Date: Nov. 6, 2025

(54) RIPARIAN SLOPE-CONSTRUCTED WETLAND AND CONSTRUCTION METHOD THEREOF

(71) Applicant: JIANGSU LVYAN ECOLOGICAL TECHNOLOGY CO., LTD., Suzhou (CN)

(72) Inventors: Bo ZHANG, Suzhou (CN); Luer ZHANG, Suzhou (CN); Yifeng SHEN, Suzhou (CN)

(21) Appl. No.: 19/266,224

(22) Filed: Jul. 11, 2025

Related U.S. Application Data
(63) Continuation of application No. PCT/CN2023/090180, filed on Apr. 24, 2023.

(30) Foreign Application Priority Data
Feb. 8, 2023 (CN) 202310087113.9

(51) Int. Cl. E02B 3/12; C02F 1/00; C02F 103/00

(52) U.S. Cl. CPC E02B 3/125; C02F 1/001; C02F 2103/007; C02F 2203/006

(57) ABSTRACT

A riparian slope-constructed wetland and a construction method thereof includes a slope wetland body, a side thereof is sequentially provided with a first inclined section, a horizontal section and a second inclined section, a first planting stratum is disposed over the first inclined section, a first guard grating is provided external to the first planting stratum, a first rock anchor extends through the first guard grating and the first planting stratum and is anchored in the slope wetland body, a second planting stratum is disposed over the second inclined section, a second guard grating is provided external to the second planting stratum, a second rock anchor extends through the second guard grating and the second planting stratum and is anchored in the slope wetland body, and the horizontal section is provided with a water filtration mechanism.

### CROSS-REFERENCE TO RELATED APPLICATIONS

This application is a continuation of PCT application serial no. PCT/CN2023/090180, filed on Apr. 24, 2023, which claims the priority and benefit of Chinese patent application serial no. 202310087113.9, filed on Feb. 8, 2023. The entireties of PCT application serial no. PCT/CN2023/090180 and Chinese patent application serial no. 202310087113.9 are hereby incorporated by reference herein and made a part of this specification.

### TECHNICAL FIELD

The present disclosure relates to the technical field of riparian wetland, and more particularly, to a riparian slope-constructed wetland and a construction method thereof.

### BACKGROUND ART

The riparian zone, as an integral structural element of river systems, exerts direct impacts on urban landscape planning and ecological environment development. To maintain riverine ecological integrity and eutrophication risks, riverbank construction must prioritize structural stability engineering, thereby preventing soil erosion phenomena along riverbanks, to enhance the aquatic ecosystem health. Consequently, slope stabilization measures must be implemented on riverbanks to enhance structural resilience.

In the related technology, slope protection for riparian wetland embankments predominantly utilizes cast-in-place concrete to form concrete protective facing along the fluvial interface. While concrete protective facings provide measurable slope stability benefits and reduce soil erosion rates to some extent, they disrupt lateral eco-connectivity between the aquatic and terrestrial ecosystems, which degrades various fluvial ecological processes, thereby impairing riverine self-purification capacity and diminishing autonomous recovery functions, ultimately exacerbating water pollution indices.

### SUMMARY

The present application provides a riparian slope-constructed wetland, which uses anchoring mechanisms of a plant root system for embankment surface protection, so as to enhance fluvial ecosystem vitality significantly while securing slope structural stability, thereby mitigating the bio-physicochemical disruptions characteristic of slope configuration in form of concrete protective facing.

The present application provides a riparian slope-constructed wetland and a construction method thereof, using the following technical solutions.

A riparian slope-constructed wetland includes a slope wetland body on a side of a river channel, where a side of the slope wetland body facing the river channel is sequentially provided with a first inclined section, a horizontal section and a second inclined section, a first planting stratum configured for plant vegetation is disposed over the first inclined section, a first guard grating is provided external to the first planting stratum, a first rock anchor is provided on the first guard grating, the first rock anchor extends through the first guard grating and the first planting stratum and is anchored in the slope wetland body, a second planting stratum configured for plant vegetation is disposed over the second inclined section, a second guard grating is provided external to the second planting stratum, a second rock anchor is provided on the second guard grating, the second rock anchor extends through the second guard grating and the second planting stratum and is anchored in the slope wetland body, and the horizontal section is provided with a water filtration mechanism configured to treat surface runoff from the first inclined section.

In the above-mentioned technical solution, the water filtration mechanism on the horizontal section filters slope runoff, so as to reduce potential pollution impacts on the river ecosystem from wastewater flowing into the river channel.

Optionally, an electric motor is mounted on the top face of the impact shield, an output end of the electric motor is fixedly connected with a first rotation shaft extending into the treatment chamber, an end of the first rotation shaft away from the electric motor extends to a bottom of the sediment trap after sequentially extending through the impact shield and the inner bottom wall of the sediment trap, the end of the first rotation shaft is fixedly connected with a first bevel gear, the inner side wall of the treatment chamber is rotatably connected with a screw rod, a second bevel gear configured to be meshed with the first bevel gear is fixedly connected to an outer side wall of the screw rod at a position adjacent to the first bevel gear, the screw rod extends through a sliding plate in a threaded connection with the screw rod, a bottom of the sliding plate is fixedly connected with a cleaning brush configured to be in contact with the baffle plate and the first filter screen, the inner side wall of the treatment chamber is further fixedly connected with a straight rod extending through the sliding plate, and an inner side wall of the sliding plate is in sliding fit with the straight rod.

By using the above-mentioned technical solution, the electric motor is started to drive the first rotation shaft and the first bevel gear to rotate. Under the meshing of the first bevel gear and the second bevel gear, the second bevel gear and the screw rod are driven to rotate, the screw rod drives the sliding plate to slide along the screw rod during the rotation thereof, and the straight rod is configured to prevent the sliding plate from rotating.

Optionally, a side wall of the backing plate is fixedly connected with a limit plate, the bottom of the sediment trap is fixedly connected with a stop rod configured to extend through the limit plate, a bottom end of the stop rod is fixedly connected with a stopper in contact with a bottom face of the limit plate.

By using the above-mentioned technical solution, the stopper is configured to prevent the backing plate from sliding down excessively, so that the sliding plate may push the thrust block to slide up.

Optionally, an inner bottom wall of the treatment chamber is provided with a stirring assembly configured to stir the clay aggregate media, the stirring assembly includes a second rotation shaft and a transmission member configured to enable the screw rod to drive the second rotation shaft to rotate, the second rotation shaft is rotatably connected to the inner bottom wall of the treatment chamber, a stirring plate is fixedly connected to an outer side wall of the second rotation shaft, the transmission member is provided on the baffle plate and includes a third rotation shaft rotatably connected to the baffle plate, a first end of the third rotation shaft is located above the baffle plate and is fixedly connected with a third bevel gear, a fourth bevel gear is fixedly connected to the outer side wall of the screw rod at a position adjacent to the third bevel gear, the fourth bevel gear is configured to be meshed with the third bevel gear, a second end of the third rotation shaft extends below the baffle plate and fixedly connected with a first sprocket, a second sprocket is fixedly connected to a top end of the second rotation shaft, a chain is engaged over an exterior of the first sprocket and an exterior of the second sprocket to synchronize a motion of the first sprocket and a motion of the second sprocket.

By using the above-mentioned technical solution, the screw rod during its rotation drives the fourth bevel gear to rotate, the third bevel gear, the third rotation shaft and the first sprocket are driven to rotate under the meshing fit of the fourth bevel gear and the third bevel gear, and the first sprocket and the second rotation shaft are driven to rotate under the transmission action of the chain, thereby enabling the stirring plate to stir the water and the clay aggregate media in the treatment chamber, so as to promote the clay aggregate media to perform sufficient filtration treatment on the water to remove impurities in the water, so that the water in the treatment chamber is not easy to generate larger pollution impacts on the river channel when being discharged to the river channel.

A construction method of the riparian slope-constructed wetland above, includes:
S1: disposing the first planting stratum and the second planting stratum over the first inclined section and the second inclined section of the slope wetland body respectively, anchoring the first planting stratum via the first guard grating and the first rock anchor, anchoring the second planting stratum via the second guard grating and the second rock anchor, and planting slope-stabilizing vegetation on the first planting stratum and the second planting stratum;
S2: excavating a groove on the horizontal section of the slope wetland body at intervals in a length direction of the slope, and providing the water filtration mechanism in the groove; and
S3: cleaning sludge residue in the sediment trap regularly, and replacing a first filter screen, so as to ensure a wastewater treatment effect of the treatment chamber.

In summary, the application has the following technical effects:
1. The first planting stratum and the second planting stratum are deployed to plant slope-stabilizing vegetation, while the first guard grating, the first rock anchor, the second guard grating and the second rock anchor are provided to achieve anchorage of the first planting stratum and the second planting stratum. The slope-stabilizing vegetation is planted to protect the slope surfaces by utilizing the anchoring function of the plant root system, so that the resulting slope wetland environment can improve the ecological environment of the river channel, thereby overcoming the defect of a poor improvement effect on ecological environment of the river channel during the slope protection through concrete protective facings.
2. When wastewater enters the sediment trap via the water ports, coarse aggregate fragments contained in the wastewater are intercepted externally by the impact shield. When the wastewater within the sediment trap flows to the first filter screen through the drain outlet on the inner bottom wall of the sediment trap, impurities such as foliar debris and silt agglomerates contained in the wastewater are retained within the sediment trap when the wastewater flows through the drain outlet. Impurities in the wastewater are further filtered out through the first filter screen and the clay aggregate media, so as to achieve layer-by-layer filtration treatment of the wastewater, such that the wastewater generated on the slope is not easily discharged directly into the river channel, thereby minimizing ecological impact on river ecosystems.
3. When filtering the wastewater by the treatment chamber, the electric motor is started to drive the first rotation shaft to rotate, and the screw rod is driven to rotate by the coordinated action of the first bevel gear and the second bevel gear, so that the sliding plate moves the cleaning brush, to clean the first filter screen by the cleaning brush, thereby preventing the meshes of the first filter screen from being blocked, to ensure the filtration effect on the wastewater. The first rotation shaft is driven to perform bidirectional rotation by the electric motor, so that cleaning brush may perform reciprocating scrubbing on the surface of the first filter screen.

### BRIEF DESCRIPTION OF THE DRAWINGS

FIG. 1 is a schematic structural diagram showing a riparian slope-constructed wetland;

FIG. 2 is a schematic diagram showing the interfacing structure among a treatment chamber, a sediment trap and an impact shield according to the present application;

FIG. 3 is a schematic diagram showing the structure of an overflow conduit according to the present application;

FIG. 4 is a schematic diagram showing the installation configuration for the impact shield, the sediment trap and a leveling block according to the present application;

FIG. 5 is a schematic diagram showing the interfacing structure among an electric motor, a screw rod, a sliding plate and a filter screen according to the present application;

FIG. 6 is a schematic diagram showing the interfacing structure between the screw rod and a stirring assembly according to the present application;

FIG. 7 is a schematic diagram showing the interfacing structure among the sliding plate, the sediment trap and an unblocking assembly according to the present application; and

FIG. 8 is a schematic cross-sectional view of a protective shell according to the present application.

### DETAILED DESCRIPTION

The present disclosure will be further described in detail below with reference to the accompanying drawings, where like components are designated by like reference numerals. It should be noted that the terms “front”, “rear”, “left”, “right”, “upper”, “lower”, “bottom face” and “top face” used in the following description refer to the orientations shown in the drawings. The terms “inner” and “outer” respectively refer to directions toward or away from the geometric center of specified components.

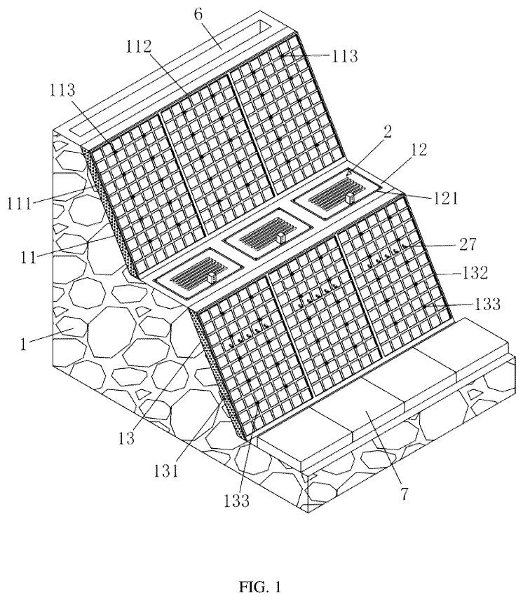

The present disclosure discloses a riparian slope-constructed wetland, as shown in FIG. 1, including a slope wetland body 1 on one side of a river channel, a first planting stratum 111, a second planting stratum 131, a first guard grating 112, and a second guard grating 132. The slope wetland body 1 is sequentially provided with a first inclined section 11, a horizontal section 12 and a second inclined section 13 from top to bottom. The first planting stratum 111 is disposed over the first inclined section 11 and vegetated with one or more species selected from Buddleja davidii, Geum aleppicum, and Amorpha fruticosa. The first guard grating 112 is arranged external to the first planting stratum 111 and provided with multiple first rock anchors 113 that penetrate through the first guard grating 112 and the first planting stratum 111 before anchorage within the slope wetland body 1. The second planting stratum 131 is disposed over the second inclined section 13 and vegetated with one or more plant species selected from Chrysopogon zizanioides, Acorus calamus, Phragmites australis and Hemarthria compressa. The second guard grating 132 is arranged external to the second planting stratum 131 and provided with multiple second rock anchors 133 that penetrate through the second guard grating 132 and the second planting stratum 131 before anchorage within the slope wetland body 1. The slope wetland body 1 is provided with an intercepting drain 6 adjacent to the crest of the first inclined section 11, and a vegetated crib mattress wall 7 is installed proximate to the toe of the second inclined section 13.

The first planting stratum 111 and the second planting stratum 131 are deployed to plant slope-stabilizing vegetation, while the first guard grating 112, the first rock anchor 113, the second guard grating 132 and the second rock anchor 133 are provided to achieve anchorage of the first planting stratum 111 and the second planting stratum 131. The slope-stabilizing vegetation is planted to protect the slope surfaces by utilizing the anchoring function of the plant root system, so that the resulting slope wetland environment can improve the ecological environment of the river channel, thereby overcoming the defect of a poor improvement effect on ecological environment of the river channel during the slope protection through concrete protective facings. The intercepting drain 6 buffers torrential flows, enhances scour resistance of the slope wetland body 1. The vegetated crib mattress wall 7 has a good soil stabilization performance, effectively preventing slope mass movement.

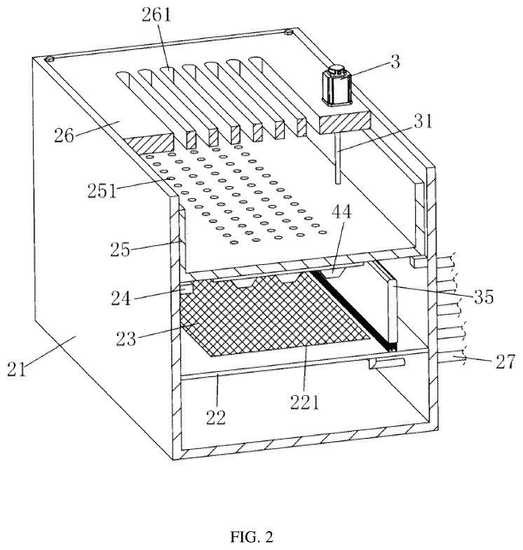

As shown in FIGS. 1 and 2, the top face of the horizontal section 12 is provided with a plurality of grooves 121 at intervals in the length direction of the slope, and the plurality of grooves 121 are each internally provided with a water filtration mechanism 2 for treating surface runoff from the first inclined section 11. The water filtration mechanism 2 includes a treatment chamber 21, a baffle plate 22, a sediment trap 25 and an impact shield 26 within the groove 121. The baffle plate 22 is fixedly connected to the inner side wall of the treatment chamber 21, the baffle plate 22 is provided with a first opening 221, and a first filter screen 23 is fixedly connected to the inner side wall of the first opening 221. A leveling block 24 is fixedly connected at each of four corners of the inner side wall of the treatment chamber 21 above the baffle plate 22. The sediment trap 25 is provided on the top faces of the leveling blocks 24, a plurality of drain outlets 251 are provided on the inner bottom wall the sediment trap 25, and the drain outlet 251 features an inverted flared conical configuration. The impact shield 26 is mounted on the sediment trap 25, a plurality of water ports 261 are configured on the impact shield 26, and clay aggregate media is placed on the inner bottom wall of the treatment chamber 21.

Wastewater flows down from the first inclined section 11 enters the sediment trap 25 via the water ports 261. Coarse aggregate fragments contained in the Wastewater are intercepted externally by the impact shield 26. When the wastewater within the sediment trap 25 traverses the drain outlet 251, impurities such as foliar debris and silt agglomerates contained in the wastewater are retained on the inner side wall of the sediment trap 25 at the bottom end thereof. Wastewater delivered to the first filter screen 23 undergoes filtration by the first filter screen, subsequently is conveyed to the position where the clay aggregate media is located. Large-particle sand and gravel in the wastewater are processed through the first filter screen 23, and then small-particle impurities in the wastewater are filtered through the clay aggregate media, so as to achieve layer-by-layer filtration treatment of the wastewater.

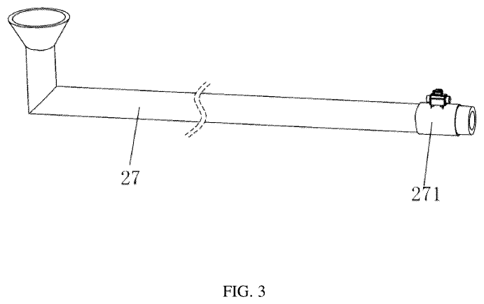

As shown in FIGS. 1, 2 and 3, a plurality of overflow conduits 27 are fixedly connected to a side wall of the treatment chamber 21 near the second inclined section 13. One end of the overflow conduit 27 is located inside the treatment chamber 21, the end of the overflow conduit 27 located inside the treatment chamber 21 is shaped like an upward-flared funnel, while an end of the overflow conduit 27 away from the treatment chamber 21 extends out of the second planting stratum 131 after passing through the slope wetland body 1 and the second planting stratum 131, and the end of the overflow conduit 27 extending out of the second planting stratum 131 is provided with a valve 271.

When the wastewater discharge operation is performed, the valve 271 on the overflow conduit 27 is opened. When the wastewater level reaches the opening of the overflow conduit 27, the wastewater is discharged into the wetland river channel via the overflow conduit 27, so that the wastewater generated on the slope is not easily discharged directly into the river channel, thereby minimizing ecological impact on river ecosystems. When the wastewater level reaches the opening, the wastewater is not easily discharged via the overflow conduit 27, so that the wastewater can be sufficiently filtered in the treatment chamber 21.

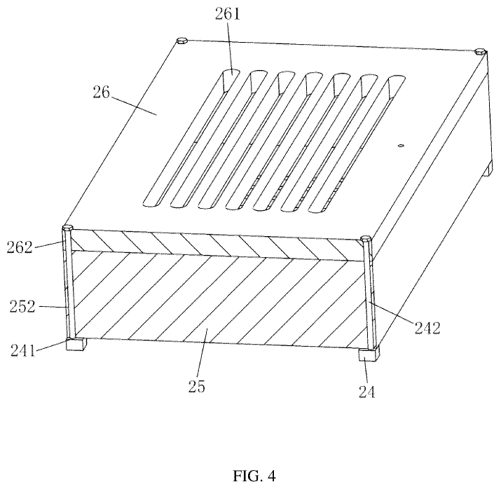

As shown in FIGS. 2 and 4, the top face of the leveling block 24 is configured with a threaded hole 241. A first through hole 252 is formed on the bottom face of the sediment trap 25 at a position corresponding to the threaded hole 241. A second through hole 262 matched with the first through hole 252 is configured on the bottom surface of the impact shield 26 at a position corresponding to the first through hole 252. An inner side wall of the threaded hole 241 is in threaded connection with a threaded rod 242 extending through the first through hole 252 and the second through hole 262.

The sediment trap 25 and the impact shield 26 are sequentially placed in the treatment chamber 21, the first through hole 252, the second through hole 262 and the threaded hole 241 at corresponding positions are aligned, and the threaded rod 242 is screwed with the inner side wall of the threaded hole 241 after passing through the first through hole 252 and the second through hole 262, thereby completing the installation of the sediment trap 25 and the impact shield 26 in the treatment chamber 21, which is simple and convenient, and is convenient for the removal of the impact shield 26 and the sediment trap 25.

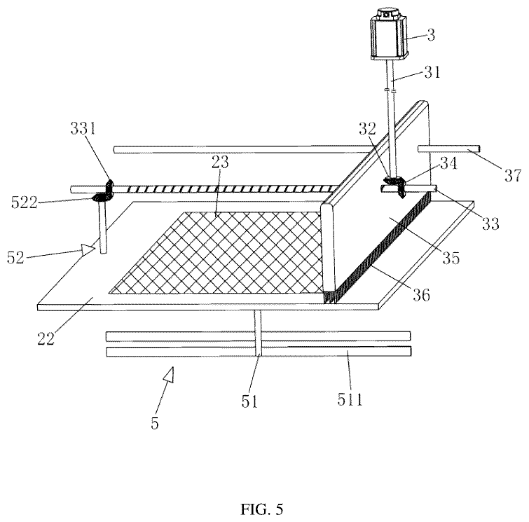

As shown in FIGS. 2 and 5, an electric motor 3 is mounted on the top face of the impact shield 26. The output end of the electric motor 3 is fixedly connected to a first rotation shaft 31 which extends to the bottom of the sediment trap 25 after sequentially extending through the impact shield 26 and the inner side wall of the sediment trap 25 at the bottom thereof. The end of the first rotation shaft 31 extending to the bottom of the sediment trap 25 is fixedly connected with a first bevel gear 32. The inner side wall of the treatment chamber 21 is rotatably connected with a screw rod 33. The outer side wall of the screw rod 33 close to the first bevel gear 32 is fixedly connected with a second bevel gear 34 configured to be meshed with the first bevel gear 32. The screw rod 33 extends through a sliding plate 35 in threaded connection with the screw rod 33. A bottom surface of the sliding plate 35 is fixedly connected with a cleaning brush 36 which can be in contact with the baffle plate 22 and the first filter screen 23. The inner side wall of the treatment chamber 21 is fixedly connected with a straight rod 37 extending the sliding plate 35. The inner side wall of the sliding plate 35 is in sliding fit with the straight rod 37.

When filtering the wastewater, the electric motor 3 is started to drive the first rotation shaft 31 to rotate, and the screw rod 33 is driven to rotate by the coordinated action of the first bevel gear 32 and the second bevel gear 34, so that the cleaning brush 36 slides along the screw rod 33 to clean the first filter screen 23, thereby preventing the meshes of the first filter screen 23 from being blocked. The first rotation shaft 31 is driven to perform bidirectional rotation by the electric motor 3, so that cleaning brush 36 may perform reciprocating scrubbing on the surface of the first filter screen 23.

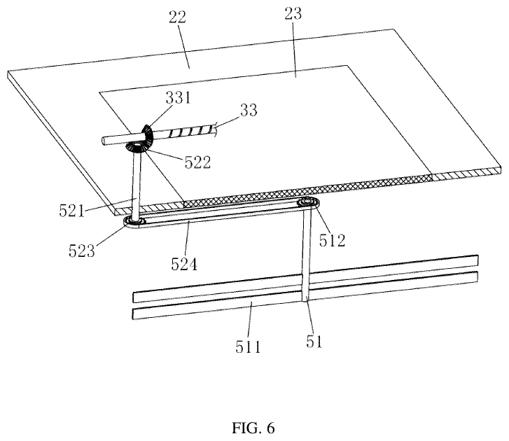

As shown in FIGS. 2, 5 and 6, the inner bottom wall of the treatment chamber 21 is provided with a stirring assembly 5 configured to stir the clay aggregate media. The stirring assembly 5 includes a second rotation shaft 51 rotatably connected to the inner bottom wall of the treatment chamber 21 and a transmission member 52 through which the screw rod 33 may drive the second rotation shaft 51 to rotate. A plurality of stirring plates 511 are fixedly connected to the outer side wall of the second rotation shaft 51. The transmission member 52 is provided on the baffle plate 22, and the transmission member 52 includes a third rotation shaft 521 rotatably connected to the baffle plate 22, a third bevel gear 522, a first sprocket 523 and a chain 524. The top end of the third rotation shaft 521 is located above the baffle plate 22, and the third bevel gear 522 is fixedly connected to the top end of the third rotation shaft 521. An outer side wall of the screw rod 33 close to the third bevel gear 522 is fixedly connected with a fourth bevel gear 331 meshed with the third bevel gear 522. The bottom end of the third rotation shaft 521 extends to the bottom of the baffle plate 22, and the first sprocket 523 is fixedly connected to the bottom end of the third rotation shaft 521. The top end of the second rotation shaft 51 is fixedly connected with a second sprocket 512. The chain 524 is engaged over the exterior of the first sprocket 523 and the second sprocket 512 to synchronize the motion of the first sprocket 523 and the second sprocket 512.

During the rotation of the screw rod 33, the third rotation shaft 521 is driven to rotate by the coordinated action of the third bevel gear 522 and the fourth bevel gear 331, such that the second rotation shaft 51 drives the stirring plate 511 to stir the clay aggregate media under the transmission action of the first sprocket 523, the chain 524 and the second sprocket 512, so as to facilitate efficient filtration of wastewater through the clay aggregate media.

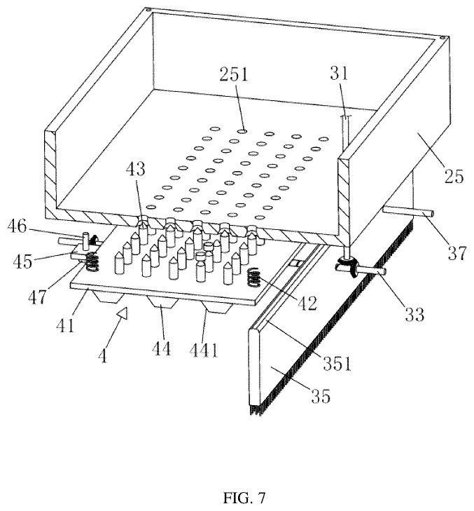

As shown in FIGS. 2 and 7, under the sediment trap 25 an unblocking assembly 4 configured to prevent the drain outlet 251 from being blocked is provided. The unblocking assembly 4 includes a backing plate 41 under the sediment trap 25, a plurality of thrust blocks 44 and a plurality of tapered rods 43 configured to extend to the top of the drain outlet 251. A top face of the backing plate 41 is fixedly connected with a first spring 42, an end of the first spring 42 away from the backing plate 41 is fixedly connected with the bottom face of the sediment trap 25. The plurality of tapered rods 43 are fixedly connected to the top face of the backing plate 41 at positions corresponding to the drain outlets 251, and the plurality of thrust blocks 44 are arranged at intervals on the bottom face of the backing plate 41 in the sliding direction of the sliding plate 35. Two side walls of the thrust block 44 in the length direction are both configured as inclined faces 441, and the thrust block 44 is an inverted isosceles trapezoidal frustum. Two side walls along the length direction of the sliding plate 35 at the top face thereof are both formed with fillets 351 matching the inclined faces 441, and the shortest distance between two adjacent thrust blocks 44 is greater than the width of the sliding plate 35. A side wall of the backing plate 41 away from the river channel is fixedly connected with a limit plate 45, and the bottom face of the sediment trap 25 is fixedly connected with a stop rod 46 extending through the limit plate 45 and in sliding fit with the inner side wall of the limit plate 45. The bottom end of the stop rod 46 is fixedly connected with a stopper 47 in contact with the bottom face of the limit plate 45.

Through the coordinated action of the fillets 351 and the inclined face 441, the sliding plate 35 presses the thrust block 44 to move the backing plate 41 and the tapered rods 43 upwards during the reciprocating sliding, so that the top ends of the tapered rods 43 extend through the drain outlets 251 to dredge the drain outlets 251, which reduces the possibility of the drain outlet 251 being blocked. Additionally, the coordinated action of the limit plate 45 and the stop rod 46 restricts displacement of the backing plate 41, ensuring the unclogging effect on the drain outlets 251 by the tapered rod 43. The stopper 47 is provided to prevent the limit plate 45 from falling off from the stop rod 46.

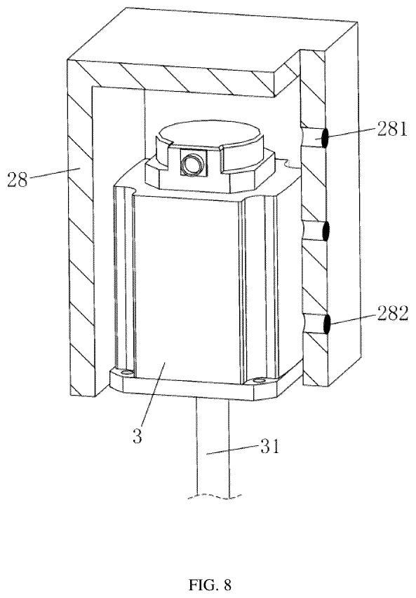

As shown in FIGS. 2 and 8, a protective shell 28 covering the outside of the electric motor 3 is fixedly connected to the top face of the impact shield 26. A plurality of heat dissipation holes 281 are formed on the side wall of the protective shell 28 close to the river channel. A second filter screen 282 is fixedly connected to the inner side walls of the plurality of heat dissipation holes 281.

The protective shell 28 is configured to protect the electric motor 3 so that the electric motor 3 is not easily damaged. The heat dissipation holes 281 are provided to timely discharge the heat generated by the electric motor 3 during its operation to prevent excessive temperature buildup within the protective shell. The second filter screen 282 is provided to block external dust and impurities, thereby remaining a clean environment within the protective shell 28.

A construction method of a riparian slope-constructed wetland includes following specific steps:
S1: disposing a first planting stratum 111 and a second planting stratum 131 over a first inclined section 11 and a second inclined section 13 of a slope wetland body 1 respectively, anchoring the first planting stratum 111 via a first guard grating 112 and a first rock anchor 113, anchoring the second planting stratum 131 via a second guard grating 132 and a second rock anchor 133, and planting slope-stabilizing vegetation on the first planting stratum 111 and the second planting stratum 131;
S2: excavating a groove 121 on a horizontal section 12 of the slope wetland body 1 at intervals in the length direction of the slope, and providing a water filtration mechanism 2 in the groove 121; and
S3: performing periodic removal of sediment residue within the sediment trap 25 and replacement of the first filter screen 23, to maintain wastewater treatment performance in the treatment chamber 21.

Implementation Principle: the slope-stabilizing vegetation are planted over the first planting stratum 111 and the second planting stratum 131, the first guard grating 112 is mounted external to the first planting stratum 111 and then the first guard grating 112 and the first planting stratum 111 are anchored via the first rock anchor 113, the second guard grating 132 is mounted external to the second planting stratum 131 and then the second guard grating 132 and the second planting stratum 131 are anchored via the second rock anchor 133, and the slope is stabilized via the slope-stabilizing vegetation planted over the first planting stratum 111 and the second planting stratum 131.

During precipitation conditions, when wastewater flows down from the first inclined section 11 to the horizontal section 12, it enters the sediment trap 25 via the water ports 261 at the impact shield 26. Coarse aggregate fragments contained in the wastewater are intercepted externally by the impact shield 26. When the wastewater within the sediment trap 25 flows to the first filter screen 23 through the drain outlet 251 on the inner bottom wall of the sediment trap 25, impurities such as foliar debris and silt agglomerates contained in the wastewater are retained within the sediment trap 25 when the wastewater flows through the drain outlet 251. Large-particle sand and gravel in the wastewater are further filtered out through the first filter screen 23. Then small-particle impurities in the wastewater are filtered through the clay aggregate media when the wastewater flows down to the clay aggregate media, so as to achieve layer-by-layer filtration treatment of the wastewater through the impact shield 26, the first filter screen 23 and the clay aggregate media.

The valve 271 on the overflow conduit 27 is opened. When the wastewater level in the treatment chamber 21 reaches the opening of the overflow conduit 27, the wastewater is discharged into the wetland river channel via the overflow conduit 27, so that the wastewater generated on the slope is not easily discharged directly into the river channel, thereby minimizing ecological impact on river ecosystems.

When filtering the wastewater by the treatment chamber 21, the electric motor 3 is started to drive the first rotation shaft 31 to rotate, and the screw rod 33 is driven to rotate by the coordinated action of the first bevel gear 32 and the second bevel gear 34, so as to drive the sliding plate 35 to slide along the surface of the screw rod 33 during the rotation of the screw rod 33, so that the cleaning brush 36 clean the first filter screen 23, thereby preventing the meshes of the first filter screen 23 from being blocked. The first rotation shaft 31 is driven to perform bidirectional rotation by the electric motor 3, so that cleaning brush 36 may perform reciprocating scrubbing on the surface of the first filter screen 23.

During the rotation of the screw rod 33, the third rotation shaft 521 is driven to rotate by the coordinated action of the third bevel gear 522 and the fourth bevel gear 331, such that the second rotation shaft 51 drives the stirring plate 511 to stir the clay aggregate media under the transmission action of the first sprocket 523, the chain 524 and the second sprocket 512, so as to facilitate efficient filtration of wastewater through the clay aggregate media.

In the sliding process of the sliding plate 35, the fillet 351 on the side wall of the sliding plate 35 at the top face thereof gradually approaches the inclined face 441 on the thrust block 44 and comes into contact with the inclined face 441. Through the coordinated action of the fillets 351 and the inclined face 441, the sliding plate 35 presses the thrust block 44 to move the backing plate 41 and the tapered rods 43 upwards, so that the top ends of the tapered rods 43 extend through the drain outlets 251 to dredge the drain outlets 251, which reduces the possibility of the drain outlet 251 being blocked. Through the coordinated action of the thrust block 44, the first spring 42 and the sliding plate 35, the drain outlets 251 may be unclogged by the tapered rods 43 during the reciprocating sliding of the sliding plate 35. Additionally, the coordinated action of the limit plate 45 and the stop rod 46 restricts displacement of the backing plate 41 during the vertical reciprocating movement of the backing plate 41, thereby ensuring the unclogging effect on the drain outlets 251 by the tapered rod 43.

The protective shell 28 outside the electric motor 3 is configured to protect the electric motor 3 so that the electric motor 3 is not easily damaged. The heat dissipation holes 281 are provided to discharge the heat generated by the electric motor 3 during its operation. The second filter screen 282 on the inner side wall of the heat dissipation hole 281 is to filter out external dust and impurities, thereby preventing the external dust and impurities from entering into the protective shell 28.

The above describes optional embodiments of the present application, which are not intended to limit the scope of protection of the present application. Therefore, any equivalent modifications made based on the structure, shape, or principles of the present application shall fall within the protection scope of the present application.

### LIST OF REFERENCE SIGNS

1 slope wetland body
11 first inclined section
111 first planting stratum
112 first guard grating
113 first rock anchor
12 horizontal section
121 groove
13 second inclined section
131 second planting stratum
132 second guard grating
133 second rock anchor
2 water filtration mechanism
21 treatment chamber
22 baffle plate
221 first opening
23 first filter screen
24 leveling block
241 threaded hole
242 threaded rod
25 sediment trap
251 drain outlet
252 first through hole
26 impact shield
261 water port
262 second through hole
27 overflow conduit
271 valve
28 protective shell
281 heat dissipation hole
282 second filter screen
3 electric motor
31 first rotation shaft
32 first bevel gear
33 screw rod
331 fourth bevel gear
34 second bevel gear
35 sliding plate
351 fillet
36 cleaning brush
37 straight rod
4 unblocking assembly
41 backing plate
42 first spring
43 tapered rod
44 thrust block
441 inclined face
45 limit plate
46 stop rod
47 stopper
5 stirring assembly
51 second rotation shaft
511 stirring plate
512 second sprocket
52 transmission member
521 third rotation shaft
522 third bevel gear
523 first sprocket
524 chain
6 intercepting drain
7 vegetated crib mattress wall

What is claimed is:

1. A riparian slope-constructed wetland, comprising a slope wetland body on a side of a river channel, wherein a side of the slope wetland body facing the river channel is sequentially provided with a first inclined section, a horizontal section and a second inclined section, a first planting stratum configured for plant vegetation is disposed over the first inclined section, a first guard grating is provided external to the first planting stratum, a first rock anchor is provided on the first guard grating, the first rock anchor extends through the first guard grating and the first planting stratum and is anchored in the slope wetland body, a second planting stratum configured for plant vegetation is disposed over the second inclined section, a second guard grating is provided external to the second planting stratum, a second rock anchor is provided on the second guard grating, the second rock anchor extends through the second guard grating and the second planting stratum and is anchored in the slope wetland body, and the horizontal section is provided with a water filtration mechanism configured to treat surface runoff from the first inclined section.

2. The riparian slope-constructed wetland according to claim 1, wherein a top face of the horizontal section is provided with a groove, the water filtration mechanism comprises a treatment chamber disposed in the groove, a baffle plate is fixedly connected to an inner side wall of the treatment chamber and is configured with a first opening, a first filter screen is fixedly connected to an inner side wall of the first opening, the inner side wall of the treatment chamber is further fixedly connected with a leveling block above the baffle plate, a sediment trap is provided on a top face of the leveling block, an inner bottom wall of the sediment trap is provided with a drain outlet, an impact shield is mounted on the sediment trap, a top face of the impact shield is configured with a water port, and clay aggregate media is placed in the treatment chamber below the baffle plate.

3. The riparian slope-constructed wetland according to claim 2, wherein an electric motor is mounted on the top face of the impact shield, an output end of the electric motor is fixedly connected with a first rotation shaft extending into the treatment chamber, an end of the first rotation shaft away from the electric motor extends to a bottom of the sediment trap after sequentially extending through the impact shield and the inner bottom wall of the sediment trap, the end of the first rotation shaft is fixedly connected with a first bevel gear, the inner side wall of the treatment chamber is rotatably connected with a screw rod, a second bevel gear configured to be meshed with the first bevel gear is fixedly connected to an outer side wall of the screw rod at a position adjacent to the first bevel gear, the screw rod extends through a sliding plate in a threaded connection with the screw rod, a bottom of the sliding plate is fixedly connected with a cleaning brush configured to be in contact with the baffle plate and the first filter screen, the inner side wall of the treatment chamber is further fixedly connected with a straight rod extending through the sliding plate, and an inner side wall of the sliding plate is in sliding fit with the straight rod.

4. The riparian slope-constructed wetland according to claim 3, wherein an unblocking assembly configured to prevent the drain outlet from being blocked is provided under the sediment trap, the unblocking assembly comprises a backing plate under the sediment trap, the backing plate is fixedly connected to the bottom of the sediment trap via a first spring, a tapered rod is fixedly connected to a top face of the backing plate at a position corresponding to the drain outlet, the tapered rod is configured to extend through and out of the drain outlet, a bottom face of the backing plate is fixedly connected with a thrust block, two side walls of the thrust block in a length direction of the thrust block are both configured as inclined faces, two side walls of the sliding plate in a length direction of the sliding plate are both formed with fillets at a top of the sliding plate, and the fillets are configured to match the inclined faces.

5. The riparian slope-constructed wetland according to claim 4, wherein a side wall of the backing plate is fixedly connected with a limit plate, the bottom of the sediment trap is fixedly connected with a stop rod configured to extend through the limit plate, a bottom end of the stop rod is fixedly connected with a stopper in contact with a bottom face of the limit plate.

6. The riparian slope-constructed wetland according to claim 3, wherein an inner bottom wall of the treatment chamber is provided with a stirring assembly configured to stir the clay aggregate media, the stirring assembly comprises a second rotation shaft and a transmission member configured to enable the screw rod to drive the second rotation shaft to rotate, the second rotation shaft is rotatably connected to the inner bottom wall of the treatment chamber, a stirring plate is fixedly connected to an outer side wall of the second rotation shaft, the transmission member is provided on the baffle plate and comprises a third rotation shaft rotatably connected to the baffle plate, a first end of the third rotation shaft is located above the baffle plate and is fixedly connected with a third bevel gear, a fourth bevel gear is fixedly connected to the outer side wall of the screw rod at a position adjacent to the third bevel gear, the fourth bevel gear is configured to be meshed with the third bevel gear, a second end of the third rotation shaft extends below the baffle plate and is fixedly connected with a first sprocket, a second sprocket is fixedly connected to a top end of the second rotation shaft, a chain is engaged over an exterior of the first sprocket and an exterior of the second sprocket to synchronize a motion of the first sprocket and a motion of the second sprocket.

7. The riparian slope-constructed wetland according to claim 2, wherein an overflow conduit is fixedly connected to a side wall of the treatment chamber adjacent to the second inclined section, a first end of the overflow conduit is located inside the treatment chamber, a second end of the overflow conduit away from the treatment chamber extends out of the second planting stratum after passing through the slope wetland body and the second planting stratum, and the second end of the overflow conduit is provided with a valve.

8. The riparian slope-constructed wetland according to claim 2, wherein a protective shell covering an outside of an electric motor is fixedly connected to the top face of the impact shield, a heat dissipation hole is formed on a side wall of the protective shell facing the river channel, a second filter screen is fixedly connected to an inner side wall of the heat dissipation hole.

9. The riparian slope-constructed wetland according to claim 2, wherein the top face of the leveling block is configured with a threaded hole, a first through hole is formed on a bottom face of the sediment trap at a position corresponding to the threaded hole, a second through hole matched with the first through hole is formed at a bottom face of the impact shield at a position corresponding to the first through hole, a threaded rod is in threaded connection with an inner side wall of the threaded hole, the threaded rod is configured to extend through the first through hole and the second through hole.

10. A construction method of a riparian slope-constructed wetland according to claim 1, comprising:
S1: disposing the first planting stratum and the second planting stratum over the first inclined section and the second inclined section of the slope wetland body respectively, anchoring the first planting stratum via the first guard grating and the first rock anchor, anchoring the second planting stratum via the second guard grating and the second rock anchor, and planting slope-stabilizing vegetation on the first planting stratum and the second planting stratum;
S2: excavating a groove on the horizontal section of the slope wetland body at intervals in a length direction of a slope, and providing the water filtration mechanism in the groove; and
S3: cleaning sludge residue in a sediment trap, and replacing a first filter screen, so as to ensure a wastewater treatment effect of a treatment chamber.
